(19) United States
(12) Patent Application Publication
(10) Pub. No.: US 2024/0032492 A1
(43) Pub. Date: Feb. 1, 2024

(54) Methods And Systems For Use In Mapping Irrigation Based On Remote Data

(71) Applicant: CLIMATE LLC, Saint Louis, MO (US)

(72) Inventors: Angeles CASAS, San Francisco, CA (US); Yu LIU, Newark, CA (US); Pratik SHRIVASTAVA, Saint Louis, MO (US); Jun XIONG, Moraga, CA (US)

(21) Appl. No.: 18/225,644

(22) Filed: Jul. 24, 2023

Related U.S. Application Data
(60) Provisional application No. 63/393,805, filed on Jul. 29, 2022.

(51) Int. Cl. A01G 25/16; G06T 7/73; G06V 10/774; G06V 10/70; G06V 20/10

(52) U.S. Cl. CPC A01G 25/16; G06T 7/73; G06V 10/774; G06V 10/70; G06V 20/182; G06T 2207/10024; G06T 2207/20081; G06T 2207/30188; G06T 2207/10032

(57) ABSTRACT

Systems and methods are provided for use in mapping irrigation in fields based on remote data. One example computer-implemented method includes accessing, by a computing device, at least one image of one or more fields; applying, by the computing device, a trained model to identity at least one irrigation segment in the at least one image; compiling a map of the one or more fields including the at least one identified irrigation segment; and storing, by the computing device, the map of the at least one identified irrigation segment for the one or more fields in a memory; and/or causing display of the map of the at least one identified irrigation segment for the one or more fields at an output device.

### CROSS-REFERENCE TO RELATED APPLICATION

This application claims the benefit of, and priority to, U.S. Provisional Application No. 63/393,805, filed Jul. 29, 2022. The entire disclosure of the above application is incorporated herein by reference.

### FIELD

The present disclosure generally relates to methods and systems for use in mapping irrigation in fields, based on remote image data.

### BACKGROUND

This section provides background information related to the present disclosure which is not necessarily prior art.

Images of fields are known to be captured in various manners, including, for example, by satellites, unmanned and manned aerial vehicles, etc. The images captured in this manner may be analyzed to derive data related to the fields, including, for example, greenness or normalized difference vegetative index (NDVI) data for the fields, which may form a basis for management decisions related to the fields.

Separately, pivot irrigation systems are employed in various crop scenarios to water the crops in fields, often due to dry conditions in the fields. The irrigations systems are fixed in one location, at one end, whereby the irrigation systems pivot around that one end to deliver water in a circulator pattern.

### SUMMARY

This section provides a general summary of the disclosure, and is not a comprehensive disclosure of its full scope or all of its features.

Example embodiments of the present disclosure generally relate to computer-implemented methods for use in processing image data associated with fields. In one example embodiment, such a method generally includes accessing, by a computing device, at least one image of one or more fields; applying, by the computing device, a trained model to identity at least one irrigation segment in the at least one image; compiling a map of the one or more fields including the at least one identified irrigation segment; and storing, by the computing device, the map of the at least one identified irrigation segment for the one or more fields in a memory; and/or causing display of the map of the at least one identified irrigation segment for the one or more fields at an output device.

Example embodiments of the present disclosure also generally relate to systems for use in processing image data associated with fields. In one example embodiment, such a system generally includes a computing device configured to perform one or more operations of the methods described herein. Example embodiments of the present disclosure also generally relate to computer-readable storage media including executable instructions for processing image data associated with fields. In one example embodiment, a computer-readable storage medium includes executable instructions, which when executed by at least one processor, cause the at least one processor to perform one or more operations described herein.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments, are not all possible implementations, and are not intended to limit the scope of the present disclosure.

FIG. 1 illustrates an example system of the present disclosure configured for mapping irrigation in multiple fields, based on image data associated with the multiple fields;

FIG. 2 is a block diagram of an example computing device that may be used in the system of FIG. 1;

FIG. 3 illustrates a flow diagram of an example method, suitable for use with the system of FIG. 1, for mapping irrigation in (or to) specific segments of fields, based on image data for the fields;

FIG. 4 illustrates an example image of a field and corresponding irrigation labels for the field; and

FIG. 5 illustrates example images of fields, labels associated with the fields, and irrigation segments in the fields identified by a model trained consistent with the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In grower operations related to fields, from time to time, growers may determine to irrigate fields or segments of the fields to enhance the performance of crops in the fields. The specific use of freshwater for irrigation is limited due to the supply of freshwater in certain regions. Pivot irrigation is often used in such fields due to its high efficiency in freshwater consumption/distribution and low labor costs. Data related to the specific use of pivot irrigation systems, and the resulting irrigation, is limited, and subject to manual entry of locations, radius operation, coverage, volume of water consumed/distributed, etc. This data, however, is usable for, among other things, placement modeling of crops in the fields (e.g., seed density, etc.), disease management/modeling, and yield prediction, etc., but the lack of data or accurate data inhibits such uses of the data for purposes of conservation of land use and resources (e.g., freshwater management, etc.).

Uniquely, the systems and methods herein leverage remote data for fields, and in particular, image data associated with the fields, to map irrigation of the fields. In particular, images of the fields are accessed, and labels are applied to the fields, which indicate presence of pivot irrigation. Based on the images and the labeled data, a convolution neural network (CNN) model is trained, and validated. The trained CNN model is then used to identify irrigation segments of the fields. In this manner, the remote data, i.e., the image data, is leveraged to produce accurate data indicative of irrigation of/in the fields, which may be used for purposes of future conservation of land use and resource management (e.g., to implement subsequent irrigation treatment decisions for the field(s), etc.).

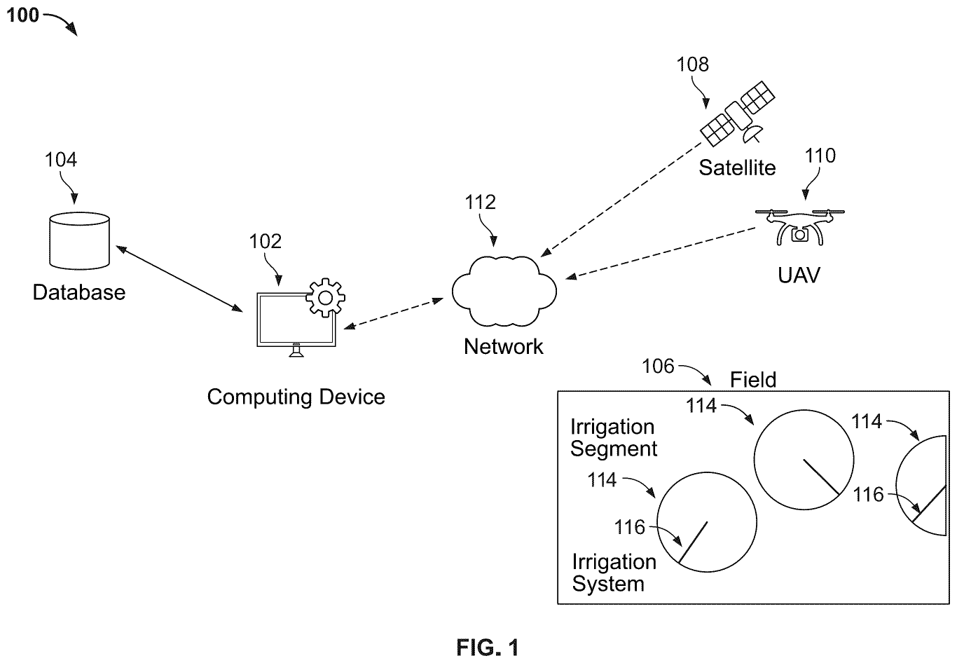

FIG. 1 illustrates an example system 100 in which one or more aspects of the present disclosure may be implemented. Although the system 100 is presented in one arrangement, other embodiments may include the parts of the system 100 (or additional parts) arranged otherwise depending on, for example, types of images available, manners in which the images are obtained (e.g., via satellites, aerial vehicles, etc.), types of fields, size and/or number of fields, crops present in the fields, crop or management practices (e.g., irrigation practices, etc.) in the fields, etc.

As shown, the system 100 generally includes a computing device 102, and a database 104 coupled to (and in communication with) the computing device 102, as indicated by the arrowed line. The computing device 102 and database 104 are illustrated as separate in the embodiment of FIG. 1, but it should be appreciated that the database 104 may be included, in whole or in part, in the computing device 102 in other system embodiments. The computing device 102 is also coupled to (and in communication with) network 112. The network 112 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof.

That said, in general, the computing device 102 is configured to initially access a data set (or multiple data sets) including images of one or more fields from the database 104 (e.g., where the images are collected as generally described herein, for example, from satellites, from other aerial vehicles, etc.) along with irrigation data for the field(s). The computing device 102 is then configured to train a model using the accessed data for identifying irrigation in the field(s). And, once the model is trained, the computing device is configured to access a data set including images of a particular field (or fields) and use the trained model to identify irrigation in the particular field(s). The computing device 102 is configured to then map the irrigation for segments of the particular field(s).

In connection with the above, the system 100 includes various fields, which are represented herein by field 106. The fields, in general, are provided for planting, growing and harvesting crops, etc., in connection with farming or growing operations, for example. While only one field 106 is shown in FIG. 1, it should be appreciated that the field 106 may be representative of dozens, hundreds or thousands of fields associated with one or more growers. The fields may each cover several acres (e.g., at least 1 or more acre, 10 or more acres, 50 or more acres, 100 or more acres, 200 or more acres, etc.). It should also be understood that the fields may be understood to include (or to more generally refer to) growing spaces for crops, and which are exposed for satellite and aerial imaging regardless of size, etc.

Further, it should be appreciated that the fields may be viewed as including multiple segments, which are different from one another in images of the fields, whereby the segments may be one or more meters by one or more meters in size, or larger or smaller, etc.

In this example embodiment, each of the fields is subject to planting, growing and harvesting of crops in various different seasons. In connection therewith, the fields may be exposed to different machinery, management practices (e.g., treatments, harvesting practices, etc.), etc. One management practice, in particular, includes irrigation. As is shown in FIG. 1, the field 106 includes multiple irrigation segments 114. Each of the irrigation segments 114 includes a generally circular shape, or a portion of the generally circular shape. For example, a half generally circular shape is included in FIG. 1, as it abuts an edge of the field 106, thereby preventing irrigation of a neighboring field or region. Each of the irrigation segments 114 is illustrated with (or in association with) an irrigation system 116, which is disposed generally on the radius of the given irrigation segment 114 and configured to pivot (and rotate in a generally circular pattern) from a center point of the irrigation segment 114. In this manner, the irrigation system 116 pivots to deliver water to the irrigation segment 114. While three irrigation segments 114 and three irrigation systems 116 are included in the field 106 for purposes of illustration, it is common for one irrigation system 116 to be used, per field, and moved within the field 106 to water the different irrigation segments 114. It is also common for the irrigation segments 114 to cover substantially all of the field 106, or certain portions of the field 106, as desired by a grower, for example. Consequently, the irrigation segments 114 may define a variety of different patterns in various fields, wit the one or more irrigation system 116 used to irrigate the irrigation segments 114.

Further, the system 100 includes multiple image capture devices, including, in this example embodiment, a satellite 108 and an unmanned aerial vehicle (UAV) 110. In connection therewith, an image captured by (or from) the satellite 108 may be referred to as a sat image. And, an image captured by (or from) the UAV 110 may be referred to as a UAV image. While only one satellite 108 and one UAV 110 are illustrated in FIG. 1, for purposes of simplicity, it should be appreciated that system 100 may include multiple satellites and/or multiple UAVs (or may include access to such satellite(s) and/or such UAV(s)). What's more, the same and/or alternate image capture devices (e.g., including a manned aerial vehicle (MAV), etc.) may be included in other system embodiments.

With respect to FIG. 1, in particular, the satellite 108 is disposed in orbit about the Earth (which includes the field 106) and is configured to capture images of the field 106 and various other fields. As indicated above, the satellite 108 may be part of a collection of satellites (including multiple companion satellites) that orbit the Earth and captures images of different fields, including the field 106. Examples of satellite images may include, for instance, Copernicus Sentinel-2 images, etc. In this example embodiment, the satellites (including the satellite 108) form a network of satellites, which, individually and together, may be configured to capture images, at an interval of once per N days, where N may include one day, two days, five days, weekly, ten days, 15 days, 30 days, or another number of days, or on specific dates (e.g., relative to planting, harvest, etc.), etc. Thus, for example, the satellite 108 (in combination with other satellites) may capture images of the field 106, at an interval of one image per day for a period on months (e.g.,. June to August, etc.).

In this example, the satellite 108 is configured to capture images having a spatial resolution of about one meter or more by about one meter or more per pixel, or other resolutions (e.g., about five meters squared per pixel, about twenty meters squared per pixel, etc.), etc. In some examples, the images may include Sentinel-2 images, for example, which have a resolution of about ten meters squared per pixel.

The UAV 110 may be configured to capture images at the same, similar or different intervals to that described for the satellite 108 (e.g., once per N days, where N may include one day, two days, five days, weekly, ten days, 15 days, 30 days, or another number of days, etc.) or on (or for) specific dates (e.g., relative to planting, harvest, etc.). The UAV 110, though, generally captures image at a higher spatial resolution than the satellite 108. For example, the UAV 110 may capture images having a spatial resolution of about five inches or less by about five inches or less per pixel, or other resolutions.

It should be appreciated that the satellite images and the UAV images may be upscaled or downscaled, from a spatial resolution perspective, as appropriate for use as described herein. It should also be appreciated that the satellite 108 and the UAV 110 may be configured to transmit, directly or indirectly, the captured satellite images and the captured UAV images, respectively, to the computing device 102 and/or the database 104 (e.g., via the network 112, etc.), whereby the images are stored in the database 104. The images may be organized, in the database 104, by location, date/time, and/or field, etc., as is suitable for use as described herein.

In this example embodiment, the computing device 102 is configured to select an example field 106, or region thereof, and to retrieve similar images for the field 106. In doing so, for example, the computing device 102 may be configured to leverage the Descartes GVS tool to select, by user input, the field 106, whereby the tool returns images, or identifies images, having similar features to the field 106 (which may or may not include images of the actual field 106). In connection with pivot irrigation, the tool is configured to return or identify images with similar pivot (or generally circular) patterns being apparent in the images. By repeatedly selecting different fields in which pivot irrigation is a ground truth (i.e., known irrigation fields), or segments thereof, the tool is configured to return or identify a substantial set of images, which includes features indicative of pivot irrigation. In other embodiments, the computing device 102 may be configured to retrieve the images from the database 104, for example, based on one or more other grouping, characteristic, etc. of the images and then use the retrieved images as described herein (in other words, the computing device may be configured to retrieve the images without using the Descartes GVS tool, etc.).

The computing device 102 is configured to receive or retrieve the identified images (e.g., from the database 104, etc.) over an interval (e.g., one of the intervals described above with regard to the satellite 108 and/or the UAV 110, etc.), including, for example, from June and August. The computing device 102 is then configured to process the images, whereby one or more indices and/or other combinations of the band data included in the images may be compiled. For example, the images, and more specifically each pixel of the images, may include data (or wavelength band data or band data) related to the color red (R) (e.g., having wavelengths ranging between about 635 nm and about 700 nm, etc.), the color blue (B) (e.g., having wavelengths ranging between about 490 nm and about 550 nm, etc.), the color green (G) (e.g., having wavelengths ranging between about 520 nm and about 560 nm, etc.), and near infrared (NIR) (e.g., having wavelengths ranging between about 800 nm and about 2500 nm, etc.), etc.

The computing device 102, in this example embodiment, may then be configured to determine median RGB pixel values of a series of the images (e.g., per pixel, per image, etc.), which are included in images for the respective fields. This may be done for all images over a given interval of images (e.g., images captured between June and August, etc.), whereby a single median is determined for the interval. Alternatively, the median may be determined for the images for multiple different intervals within a larger interval (e.g., for each month or each week, etc. between June and August; etc.). And, an image composite may then be generated using the median RGB pixel values.

Then, the computing device 102 is configured to label the images for irrigation segments included therein (e.g., outline or highlight pivot irrigated areas or segments in the images, etc.). The labeling may be performed in any suitable manner. The images may include one, multiple, or no instances of pivot irrigation. For instance, the computing device 102 may be configured to outline all pivot irrigated areas in the provided images. In doing so, the computing device 102 is configured to apply one or more particular guidelines to identify pivot irrigation systems, what pivot irrigated areas look like, and how to label such pivot irrigated areas.

For instance, pivot irrigation may be represented in an image by a field/segment having a generally circle shape (e.g., a generally circular boundary, etc. visible by a change in field color at the edge; etc.) or portion of a generally circular shape (e.g., semi-circular or partially circular, etc.). In addition, a center of a pivot system may include a relatively bright central spot/pivot (e.g., a well pad from which water is supplied, etc.) with a long metal arm extending straight outward from the center (which has sprayers on it that water the crops), and/or generally circular arm/wheel tracks concentrically located around the central pivot.

With regard to shape, pivot irrigated fields/segments may appear as partial circles. In connection therewith, buildings, lots, small bodies of water, or other features that do not require or necessitate the use of pivot irrigation may then be included in the area not covered by the pivot arm (as the pivot arm would not likely be capable of rotating through such areas). Pivot irrigated fields/segments may also have different colors (e.g., green brown, shades thereof, etc.). This may be due to different crops being planted in the field/segment, the health of the plants in the field/segment, or whether or not the field/segment is in use or a crop in the field/segment has been harvested. Further, in some instances, pivot irrigated fields/segments may be nested within other pivot irrigated fields/segments. For instance, a portion of a semi-circular field/segment not covered by a pivot arm may contain (all or part of) a separate pivot irrigated field/segment (nested in a containing field/segment) with its own well pad, pivot arm and boundary. The nested field/segment may be smaller, larger, or even about the same size as the containing field/segment. Still further, one pivot irrigated field/segment may overlap with another pivot irrigated field/segment. For instance, well pads of neighboring pivot irrigated fields/segments may be close together such that the boundaries of the fields/segments overlap. In such cases, the entire area of both fields/segments may be labeled as pivot irrigated (without differentiating between the two boundaries).

Moreover, pivot irrigated fields/segments may also be located along borders of roads or other agricultural fields (both pivot irrigated and non-pivot irrigated). In connection therewith, in some examples, pivot irrigated segments may appear closer to generally square shapes, as their color may be maintained from their well pads in the centers of the segments to the corners bounded by roads. This may also appear where growers install end guns, which extend the reach of the sprinkler arm to the extreme ends of the field. In such cases, the entire areas are labeled as pivot irrigated, as identifiable primarily by the green (or other uniform color) (and not only the area that is under the sprinkler arm).

That said, in one example, the computing device 102 may be configured to implement the following operations to identify and label irrigation segments in images. The computing device 102 may be configured to initially review the images and identify circular and semi-circular shapes. The computing device 102 may be configured to then review the rest of each of the images for areas that may be under pivot irrigation systems. This may include identifying one or more of the following features in each of the images: well pads (which may look like small groups of bright pixels in a center/edge of circular or semi-circular areas); sprinkler arms (which may be visible as lines extending from the well pads to edges of the circular or semi-circular areas (e.g., like the radius of a circle, etc.); circular tracks from sprinkler arms, for instance, as generally concentric circles about well pads; and any circular boundaries (e.g., visible as the green of the field turns to the brown of the background, roads or other boundaries, etc.).

Once the images are analyzed/evaluated, the images and associated label data for the images is the compiled into a data set.

Next in the system 100, the computing device 102 is configured to split the data set into a training subset and a validation subset. The computing device 102 is then configured to train a machine learning model, which may include, for example, a convolutional neural network (CNN) model, and in particular, a semantic segmentation deep CNN model, etc., or other suitable model, etc. And, next, the computing device 102 may be configured to validate the trained CNN model, based on the validation subset, which, again, includes the same type of input data and irrigation labels. The CNN model is validated when a sufficient performance of the model is achieved (e.g., better than 70%, 80%, 90%, or 95% accurate, etc.).

After training, the computing device 102 is configured to access an image of a particular field, such as, for example, the field 106, including a series of images of the field 106 over time, for example. The computing device is then configured to process the data for the image in the same manner as above (e.g., derive one or more indices, etc.), and then to employ the trained model to identify irrigation, if any, in the field 106, as a whole or by segments included therein. Then, finally in the system 100, in this example, the computing device 102 is configured to generate a map of the field, which includes the irrigation label(s), if any, for the identified irrigation in the field 106. The computing device 102 is configured to then display the map to one or more users (e.g., via the FIELDVIEW service from Climate LLC, Saint Louis, Missouri; etc.). As described, the map or the underlying data associated with the fields (i.e., irrigation labels) may then be used and/or leveraged to inform one or more crop management decisions with regard to the field 106.

For example, from the above, based on the identified irrigation in the field 106 (e.g., and the mapping thereof, etc.), the computing device 102 may be configured to generate one or more instructions (e.g., scripts, plans, etc.) for treating the field 106 (e.g., the crop in the field 106, etc.). The computing device 102 may then transmit the instructions to the irrigation system(s) 116 in the field 106, to an agricultural machine, etc., whereby upon receipt, the irrigation system(s) 116, the agricultural machine, etc. automatically operate(s), in response to the instructions, to treat the crop in the field 106 (e.g., the instructions are used to control an operating parameter of the irrigation system(s) 116, the agricultural machine, etc.). Such treatment, processing, etc. of the crop, as defined by the instructions, may include activating the irrigation system(s) 116 to irrigate the field 106; directing the agricultural machine (e.g., causing operation of the machine, etc.) to apply one or more fertilizers, herbicides, pesticides, etc. (e.g., as part of a treatment plan, etc.); directing the agricultural machine (e.g., causing operation of the machine, etc.) to harvest part or all of the crop in the field 106; etc. In this way, the irrigation system(s) 116, the agricultural machine, etc. operate in an automated manner, in response to the identified irrigation in the field 106, to perform one or more subsequent agricultural tasks. For instance, in one particular example, based on the identified irrigation in the field 106 (e.g., and the mapping thereof, etc.), the computing device 102 may be configured to actuate a pump of the irrigation system(s) 116 to direct water from a reservoir of water to discharge portions of the system(s) (e.g., sprinkler heads, sprayer heads, etc.) to thereby irrigate the field 106. In addition, the computing device 102 may also be configured to actuate a motor to drive wheels of the system(s) (e.g., of a pivot irrigation system, etc.) to thereby move the discharge portions about the field 106 as desired. As such, the irrigation systems(s) may operate to irrigate the field 106 in an automated manner, upon receiving the instructions relating to the identified irrigation of the field 106.

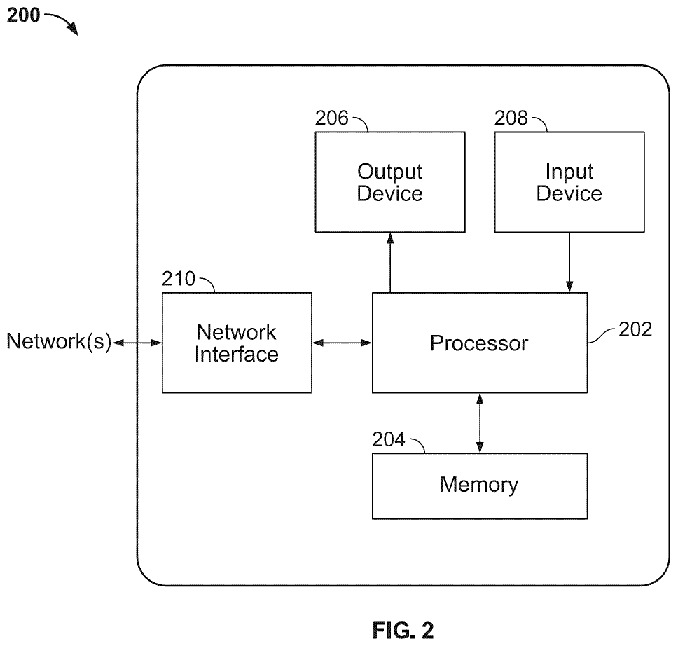

FIG. 2 illustrates an example computing device 200 that may be used in the system 100 of FIG. 1. The computing device 200 may include, for example, one or more servers, workstations, personal computers, laptops, tablets, smartphones, virtual or cloud-based devices, etc. In addition, the computing device 200 may include a single computing device, or it may include multiple computing devices located in close proximity or distributed over a geographic region, so long as the computing devices are specifically configured to operate as described herein. In the example embodiment of FIG. 1, the computing device 102 and the database 104 (and the satellite 108 and the UAV 110 and the irrigation system 116) may each include and/or be implemented in one or more computing devices consistent with (or at least partially consistent with) computing device 200. However, the system 100 should not be considered to be limited to the computing device 200, as described below, as different computing devices and/or arrangements of computing devices may be used. In addition, different components and/or arrangements of components may be used in other computing devices.

As shown in FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, a graphics processing unit (GPU), an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. In connection therewith, the memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media for storing such data, instructions, etc. In particular herein, the memory 204 is configured to store data including and/or relating to, without limitation, images, models, irrigation labels, and/or other types of data (and/or data structures) suitable for use as described herein.

Furthermore, in various embodiments, computer-executable instructions may be stored in the memory 204 for execution by the processor 202 to cause the processor 202 to perform one or more of the operations described herein (e.g., one or more of the operations of method 300, etc.) in connection with the various different parts of the system 100, such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special-purpose computing device. It should be appreciated that the memory 204 may include a variety of different memories, each implemented in connection with one or more of the functions or processes described herein.

In the example embodiment, the computing device 200 also includes an output device 206 that is coupled to (and is in communication with) the processor 202. The output device 206 may output information (e.g., irrigation maps, etc.), visually or otherwise, to a user of the computing device 200, such as a researcher, a grower, etc. It should be further appreciated that various interfaces (e.g., as defined by the FIELDVIEW service, commercially available from Climate LLC, Saint Louis, Missouri; etc.) may be displayed at computing device 200, and in particular at output device 206, to display certain information to the user. The output device 206 may include, without limitation, a liquid crystal display (LCD), a light-emitting diode (LED) display, an organic LED (OLED) display, an “electronic ink” display, speakers, etc. In some embodiments, output device 206 may include multiple devices. Additionally or alternatively, the output device 206 may include printing capability, enabling the computing device 200 to print text, images, and the like on paper and/or other similar media.

In addition, the computing device 200 includes an input device 208 that receives inputs from the user (i.e., user inputs) such as, for example, selections of fields or segments thereof, etc. The input device 208 may include a single input device or multiple input devices. The input device 208 is coupled to (and is in communication with) the processor 202 and may include, for example, one or more of a keyboard, a pointing device, a touch sensitive panel, or other suitable user input devices. It should be appreciated that in at least one embodiment an input device 208 may be integrated and/or included with an output device 206 (e.g., a touchscreen display, etc.).

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks (e.g., one or more of a local area network (LAN), a wide area network (WAN) (e.g., the Internet, etc.), a mobile network, a virtual network, and/or another suitable public and/or private network capable of supporting wired and/or wireless communication among two or more of the parts illustrated in FIG. 1, etc.) (e.g., network 112, etc.), including with other computing devices used as described herein.

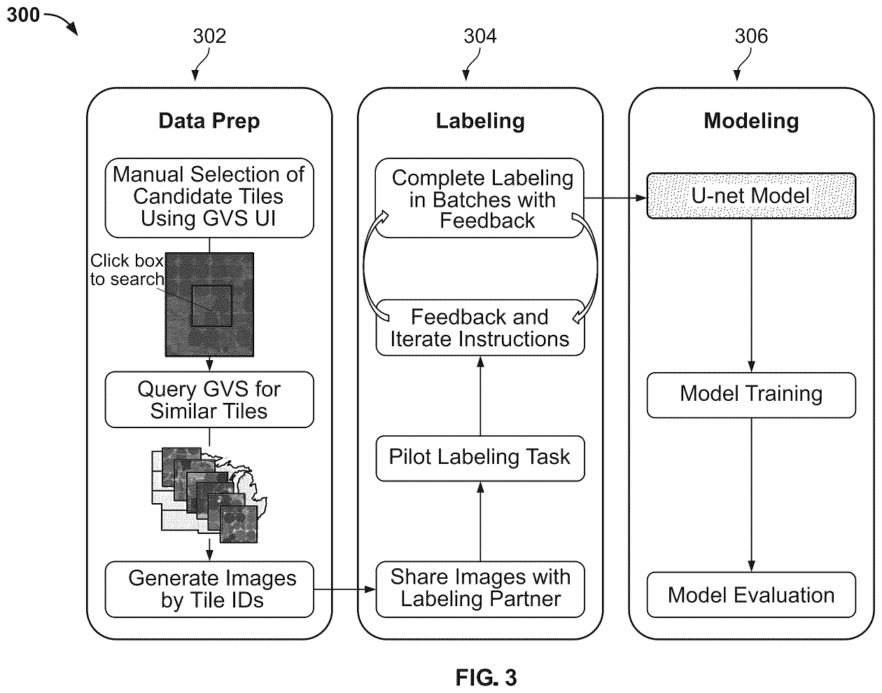

FIG. 3 illustrates an example method 300 for mapping irrigation in fields, based in image data associated with the fields. The method 300 is described herein in connection with the system 100, and may be implemented, in whole or in part, in the computing device 102 of the system 100, and also the computing device 200. However, it should be appreciated that the method 300, or other methods described herein, are not limited to the system 100 or the computing device 200. And, conversely, the systems, data structures, and the computing devices described herein are not limited to the example method 300.

At the outset in the method 300, the computing device 102 performs data preparation at 302. In particular, the computing device 102 compiles a variety of different images of fields, which are similar to a selected field, or plurality of selected fields. In this example embodiment, the computing device 102 leverages the Descartes Labs GeoVisual Search (GVS), in which multiple irrigation fields or segments of field (i.e., plots), are selected. The relevant satellite images, in this example, which include the irrigation segments, are identified (e.g., by a unique identifier, etc.) and retrieved/received. That said, it should be appreciated that the images may be identified, compiled, etc. in other manners (e.g., other than through use of the Descartes Labs GVS tool), and/or that images other than satellite images may be used (e.g., UAV images, etc.), in other embodiments.

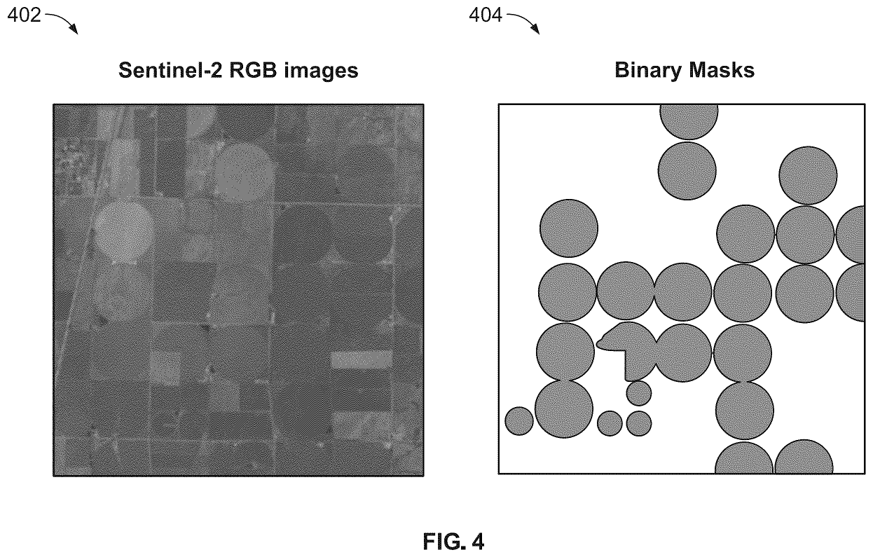

Thereafter, at 304, the computing device 102 labels the images, and in particular, labels specific segments of the images as being irrigation segments (e.g., irrigation segments 114, etc.). The labeling may be performed in a variety of different manners, for example, taking into account the guidelines provided above, etc. In one example, the images are provided to a third party partner, which labels the images through a series of labeling rules or guidelines, which are refined through feedback. An example of the labeling is shown in FIG. 4, in which a satellite image 402 is shown on the left and the corresponding binary irrigation mask or labels 404 are shown on the right. The labels are linked to the specific image, and the labels are provided or produced for each of the images in the set of images from data preparation.

At 306, then, the computing device 102 splits the data set into a training subset and a validation subset, and then trains a model (e.g., the CNN model or other suitable model, etc.) with the training subset of data. The trained model is then evaluated or validated through the validation subset of the data set. In this example embodiment, the trained CNN model for irrigation provides an accuracy of about 0.94 and an f1 score of about 0.92 at the subfield level (0 meters).

After the model is trained, the computing device 102 requests particular field data by identifying a specific field (e.g., field 106, etc.) for which irrigation is to be evaluated (e.g., automatically, in response to an input from a grower or user, etc.). In connection therewith, the computing device 102 accesses images for a period of time (e.g., monthly, etc.) and generates a composite for the image (e.g., a median or mean of the RGB values for the images, etc.).

The computing device 102 then applies the trained CNN model, whereby each pixel of the accessed/received field images is assigned irrigation segments.

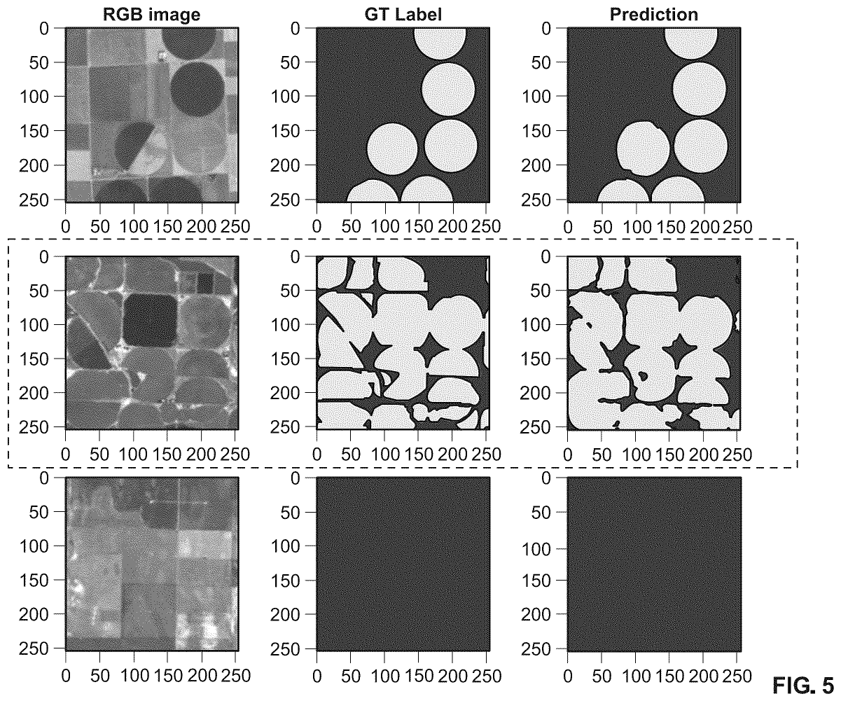

The computing device 102 then defines the irrigation map for a given image, whereby irrigation segments are identified for the field (e.g., for field 106, etc.). FIG. illustrates multiple images (at 500), including example irrigation maps (right). In addition, FIG. 5 includes three example corresponding images (to the maps) and RGB image data therefore (left), and actual labels for the specific images (center). The modeled output of irrigation mapping, then again, is provided to the right. As described, the maps or underlying data may be used and/or leveraged to inform one or more crop decisions and/or predictions with regard to the field 106 (e.g., seed density, disease modeling, yield prediction, etc.).

In view of the above, the systems and methods herein provide for mapping of irrigation in regions (e.g., in fields in the regions, etc.), based on images of the regions, through a trained CNN or other model. In this manner, an objective (and generally automated) designation of irrigation in the regions, based on image data, is provided, which avoids manual intervention and data compilation by individual growers, etc. (e.g., whereby the objective designation of irrigation may be relied upon for completeness and accuracy, etc.), etc. In turn, from the irrigation mapping, one or more crop management decisions may be implemented with regard to the regions and, more particularly, the fields in the regions.

Further, the irrigation characteristics identified/achieved via the systems and methods herein may be employed in a variety of different implementations. For example, in one implementation, the irrigation characteristics may be indicative of field conditions and utilized in selecting crops for planting, crops for harvest, treatment options for crops/fields, etc.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects, features, operations, etc. of the present disclosure may transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques, including computer software, firmware, hardware or any combination or subset thereof, wherein the technical effect may be achieved by performing at least one of the following operations: (a) accessing at least one image of one or more fields; (b) applying a trained model to identity at least one irrigation segment in the at least one image; (c) compiling a map of the one or more fields including the at least one identified irrigation segment; (d) storing the map of the at least one identified irrigation segment for the one or more fields in a memory; and/or (e) causing display of the map of the at least one identified irrigation segment for the one or more fields at an output device.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter Xis exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in processing image data associated with fields, the method comprising:
accessing, by a computing device, at least one image of one or more fields;
applying, by the computing device, a trained model to identify at least one irrigation segment in the at least one image;
compiling a map of the one or more fields including the at least one identified irrigation segment;
storing, by the computing device, the map of the at least one identified irrigation segment for the one or more fields in a memory; and
causing display of the map of the at least one identified irrigation segment for the one or more fields at an output device.

2. The computer-implemented method of claim 1, wherein the at least one image includes a series of images of the one or more fields over an interval; and
further comprising generating a composite of the images; and
wherein applying the trained model includes applying the trained model to the composite of the images.

3. The computer-implemented method of claim 2, wherein the composite of the images includes a median of RGB values of the images; and
wherein the interval includes an interval of months.

4. The computer-implemented method of claim 1, wherein the at least one irrigation segment defines at least a portion of a circle, thereby indicating pivot irrigation.

5. The computer-implemented method of claim 1, further comprising, prior to accessing the at least one image of the one or more fields:
accessing a plurality of images of a plurality of fields, each including at least one irrigation segment; and
training the model based on the accessed plurality of images and irrigation labels associated with the irrigation segments.

6. The computer-implemented method of claim 5, wherein accessing the plurality of images of the plurality of fields includes accessing the plurality of images for an interval.

7. The computer-implemented method of claim 1, further comprising instructing, by the computing device, operation of an irrigation system of the one or more fields based on the at least one identified irrigation segment.

8. The computer-implemented method of claim 7, further comprising irrigating, by the irrigation system, the one or more fields.

9. A non-transitory computer-readable storage medium including executable instructions for processing image data associated with fields, which when executed by at least one processor, cause the at least one processor to:
access at least one image of one or more fields;
apply a trained model to identify at least one irrigation segment in the at least one image;
compile a map of the one or more fields including the at least one identified irrigation segment;
store the map of the at least one identified irrigation segment for the one or more fields in a memory; and
cause display of the map of the at least one identified irrigation segment for the one or more fields at an output device.

10. The non-transitory computer-readable storage medium of claim 9, wherein the at least one image includes a series of images of the one or more fields over an interval;
wherein the executable instructions, when executed by the at least one processor, further cause the at least one processor to generate a composite of the images; and
wherein the executable instructions, when executed by the at least one processor to apply the trained model, cause the at least one processor to apply the trained model to the composite of the images.

11. The non-transitory computer-readable storage medium of claim 10, wherein the composite of the images includes a median of RGB values of the images; and
wherein the interval includes an interval of months.

12. The non-transitory computer-readable storage medium of claim 9, wherein the at least one irrigation segment defines at least a portion of a circle, thereby indicating pivot irrigation.

13. The non-transitory computer-readable storage medium of claim 9, wherein the executable instructions, when executed by the at least one process, cause the at least one processor to:
access a plurality of images of a plurality of fields, each including at least one irrigation segment; and
train the model based on the accessed plurality of images and irrigation labels associated with the irrigation segments.

14. The non-transitory computer-readable storage medium of claim 9, wherein the executable instructions, when executed by the at least one process, cause the at least one processor to instruct operation of an irrigation system of the one or more fields based on the at least one identified irrigation segment.

15. A system for use in processing image data associated with fields, the system comprising a computing device configured to:
access at least one image of one or more fields;
apply a trained model to identity at least one irrigation segment in the at least one image;
compile a map of the one or more fields including the at least one identified irrigation segment; and
store the map of the at least one identified irrigation segment for the one or more fields in a memory; and/or cause display of the map of the at least one identified irrigation segment for the one or more fields at an output device.

16. The system of claim 15, wherein the at least one image includes a series of images of the one or more fields over an interval;
wherein the computing device is further configured to generate a composite of the images; and
wherein the computing device is configured to apply the trained model to the composite of the images.

17. The system of claim 16, wherein the composite of the images includes a median of the RGB values of the images; and
wherein the interval includes an interval of months.

18. The system of claim 15, wherein the at least one irrigation segment defines at least a portion of a circle, thereby indicating pivot irrigation.

19. The system of claim 15, wherein the computing device is further configured, prior to accessing the at least one image of the one or more fields, to:
access a plurality of images of a plurality of fields, each including at least one irrigation segment; and
train the model based on the accessed plurality of images and irrigation labels associated with the irrigation segments.

20. The system of claim 19, wherein the computing device is configured, in order to access the plurality of images of the plurality of fields, to access the plurality of images for an interval.
